(19) United States
(12) Patent Application Publication
(10) Pub. No.: US 2019/0030926 A1
(43) Pub. Date: Jan. 31, 2019

(54) PRINTER

(71) Applicant: FUJITSU COMPONENT LIMITED, Tokyo (JP)

(72) Inventors: Tetsuhiro ISHIKAWA, Tokyo (JP); Masahiro Tsuchiya, Tokyo (JP)

(73) Assignee: FUJITSU COMPONENT LIMITED, Tokyo (JP)

(21) Appl. No.: 15/996,762

(22) Filed: Jun. 4, 2018

(30) Foreign Application Priority Data
Jul. 31, 2017 (JP) 2017-148403

(51) Int. Cl. B41J 13/00

(52) U.S. Cl. CPC B41J 13/0009; B41J 2/32

(57) ABSTRACT

A printer includes: a holding member configured to hold a roll of paper; an elastic member configured to support the holding member so that the holding member is slidable in a vertical direction; a first detection unit configured to detect a position of the holding member; and a second detection unit that detects a near-end of the roll of paper based on a detection result by the first detection unit.

### CROSS-REFERENCE TO RELATED APPLICATION

This application is based upon and claims the benefit of priority of the prior Japanese Patent Application No. 2017-148403 filed on Jul. 31, 2017, the entire contents of which are incorporated herein by reference.

### FIELD

A certain aspect of the embodiments is related to a printer.

### BACKGROUND

There has been conventionally known a sheet feeder having a function to detect the remaining amount of a roll of paper as disclosed in, for example, Japanese Patent Application Publication No. 2007-76849. Such a sheet feeder detects the remaining amount of a roll of paper by calculating a distance from a contact member that is in contact with the roll of paper to the bottom surface based on the rotation angle of a rotary switch.

In addition, a thermal printer having a thermal print unit is widely used as a mobile printer, an ATM, a KIOSK terminal, or a convenience store payment terminal printer. In the case where the administrator cannot reside and the timing for replacing a roll of paper is limited like ATM, implementation of a mechanism for detecting the state where the remaining amount of paper is small, that is, the so-called near-end of a roll of paper is desired.

There has been known a technique that detects the outside diameter of a roll of paper by attaching a switch or an optical sensor to the side surface or the bottom surface of a paper holder to detect the near-end of a roll of paper.

### SUMMARY

According to an aspect of the present invention, there is provided a printer including: a holding member configured to hold a roll of paper; an elastic member configured to support the holding member so that the holding member is slidable in a vertical direction; a first detection unit configured to detect a position of the holding member; and a second detection unit that detects a near-end of the roll of paper based on a detection result by the first detection unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view of a printer in accordance with a present embodiment;

FIG. 2A is a partial cross-sectional view taken along line A-A in FIG. 1 when the remaining amount of a roll of paper is large, and FIG. 2B is a partial cross-sectional view taken along line A-A in FIG. 1 when the remaining amount of a roll of paper is small;

FIG. 3A illustrates a variation of the cross-section of the printer when the remaining amount of a roll of paper is large, and FIG. 3B illustrates a variation of the cross-section of the printer when the remaining amount of a roll of paper is small;

FIG. 4A illustrates another variation of the cross-section of the printer when the remaining amount of a roll of paper is large, and FIG. 4B illustrates another variation of the cross-section of the printer when the remaining amount of a roll of paper is small;

FIG. 5A and FIG. 5C illustrate other variations of the cross-section of the printer when the remaining amount of a roll of paper is large, and FIG. 5B and FIG. 5D illustrate other variations of the cross-section of the printer when the remaining amount of a roll of paper is small;

FIG. 6A and FIG. 6C illustrate yet other variations of the cross-section of the printer when the remaining amount of a roll of paper is large, and FIG. 6B and FIG. 6D illustrate yet other variations of the cross-section of the printer when the remaining amount of a roll of paper is small; and

FIG. 7A is a cross-sectional view of the printer as viewed from the right in FIG. 1, FIG. 7B illustrates yet another variation of the cross-section of the printer when the remaining amount of a roll of paper is large, and FIG. 7C illustrates yet another variation of the cross-section of the printer when the remaining amount of a roll of paper is small.

### DESCRIPTION OF EMBODIMENTS

As the remaining amount of a roll of paper decreases, the outside diameter of the roll of paper increases due to loosening of the roll of paper. Thus, with the technique that detects the outside diameter of a roll of paper, the detection accuracy of the near-end of the roll of paper may decrease due to the increase in outside diameter of the roll of paper.

Hereinafter, embodiments of the present invention will be described with reference to the accompanying drawings.

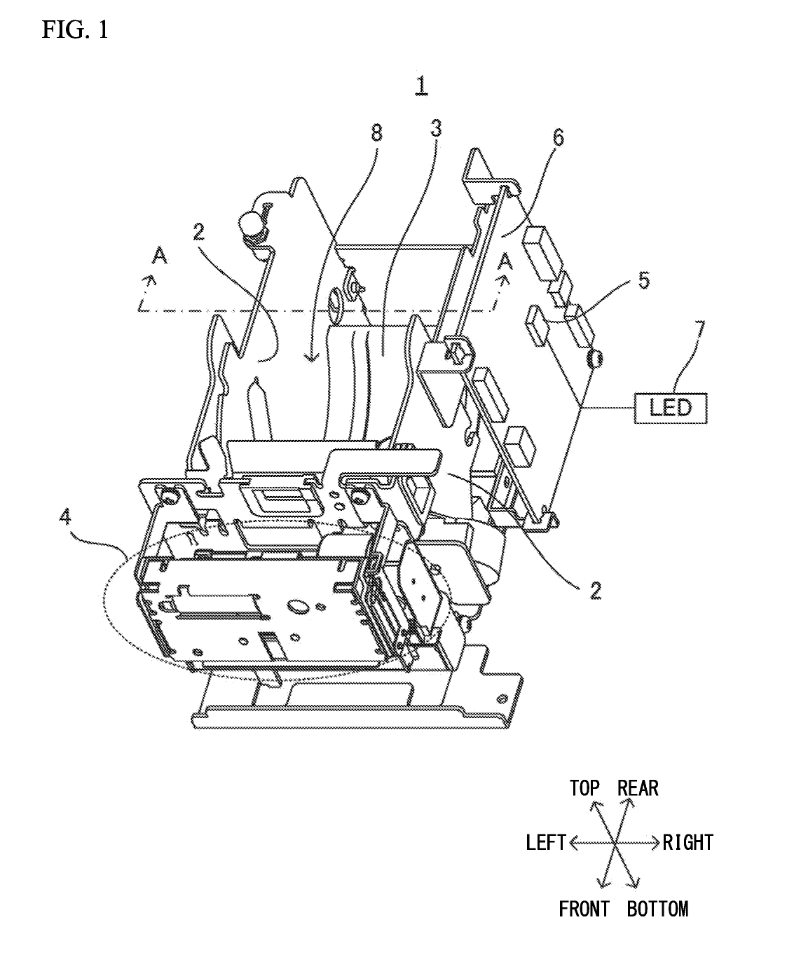

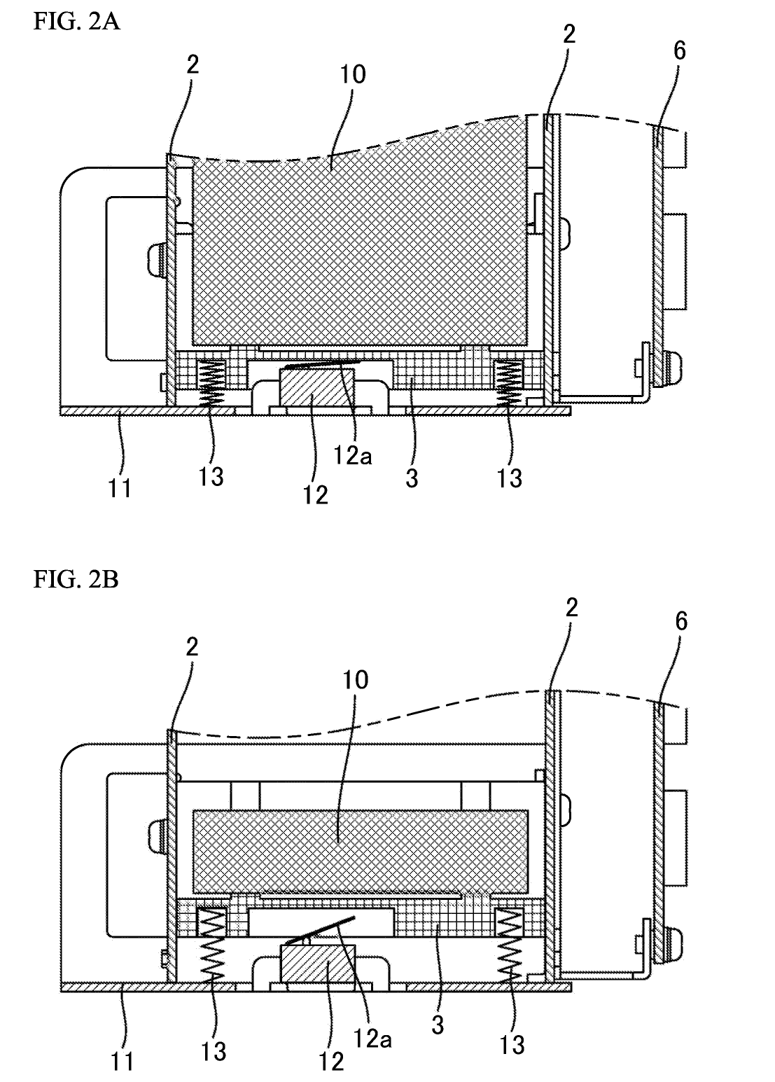

FIG. 1 is a perspective view of a printer in accordance with a present embodiment. FIG. 2A is a cross-sectional view taken along line A-A in FIG. 1 when the remaining amount of a roll of paper is large. FIG. 2B is a cross-sectional view taken along line A-A in FIG. 1 when the remaining amount of a roll of paper is small. The front and rear, the top and bottom, and the right and left of the printer are defined as illustrated in FIG. 1.

A printer 1 illustrated in FIG. 1 is, for example, a thermal printer, and is installed in a mobile printer, an ATM, or a KIOSK terminal. The printer 1 includes: an outside holder 2 that regulates the movement of a roll of paper in the right-and-left direction and holds the roll of paper; an inside holder 3 as a holding member that is slidable relative to the outside holder 2 in the vertical direction and holds the roll of paper from below; a print unit 4 that includes a thermal head and a platen roller, which are not illustrated, and prints data on a roll of paper; a microcomputer 5 as a second detection unit that controls operations of the print unit 4 and receives signals from a mechanical switch or optical sensor described later; and a circuit board 6 having the microcomputer 5 mounted thereon and attached to the side surface of the outside holder 2. The microcomputer 5 is coupled to an LED 7, and when detecting the near-end of a roll of paper, notifies the user of the near-end of the roll of paper by lighting or blinking the LED 7. The near-end of a roll of paper indicates the state in which the remaining amount of the roll of paper is below a predetermined threshold value, and indicates the state in which replacement of the roll of paper is recommended.

A roll of paper falls in a space 8 surrounded by the outside holder 2 and the inside holder 3, and is then held along the curved shape of the inside holder 3, but a roll of paper may be held by a shaft penetrating through the center of the roll of paper. When a roll of paper is held by a shaft, both ends of the shaft is rotatably supported by the outside holder 2 or the inside holder 3. The structure of the printer 1 in FIG. 1 is merely an example, and does not intend to suggest any limitation.

FIG. 2A is a partial cross-sectional view taken along line A-A in FIG. 1 when the remaining amount of a roll of paper is large. FIG. 2B is a partial cross-sectional view taken along line A-A in FIG. 1 when the remaining amount of a roll of paper is small.

In FIG. 2A and FIG. 2B, the inside holder 3 is located on a bottom plate 11 of the printer 1 through springs 13 as elastic members. The springs 13 allow the inside holder 3 to slide in the vertical direction. The spring 13 is a coil spring, but may be a plate spring or a torsion coil spring. Alternatively, an elastic body such as rubber may be used instead of the spring 13. The outside holder 2 and the bottom plate 11 function as the chassis of the printer 1.

A mechanical switch 12 as a first detection unit is located under the inside holder 3 and on the bottom plate 11. The mechanical switch 12 is surrounded by the outside holder 2, the inside holder 3, and the bottom plate 11, thus being less affected by dust or the like. The mechanical switch 12 has a protrusion portion 12a that protrudes in one direction, and detects the position of the inside holder 3 in the vertical direction based on the up-and-down motion of the protrusion portion 12a.

In the case illustrated in FIG. 2A, as the remaining amount of a roll of paper 10 is large, the roll of paper 10 weighs down the inside holder 3, and the inside holder 3 thus compresses the springs 13. In this case, the bottom surface of the inside holder 3 is in contact with the protrusion portion 12a of the mechanical switch 12, and presses the protrusion portion 12a of the mechanical switch 12. When the protrusion portion 12a of the mechanical switch 12 is pressed, an ON signal is output from the mechanical switch 12 to the microcomputer 5. Accordingly, the microcomputer 5 determines that the remaining amount of the roll of paper 10 is large.

When the remaining amount of the roll of paper 10 is small as illustrated in FIG. 2B, the restoring force of the spring 13 lifts up the inside holder 3. In this case, the bottom surface of the inside holder 3 separates from the protrusion portion 12a of the mechanical switch 12, and the mechanical switch 12 is turned off When the mechanical switch 12 is turned off, no signal is output from the mechanical switch 12 to the microcomputer 5. Accordingly, the microcomputer 5 determines that the remaining amount of the roll of paper 10 is small. That is, the microcomputer 5 is able to detect the near-end of a roll of paper. In this case, the microcomputer 5 lights or blinks the LED 7 to notify the user of the near-end of the roll of paper.

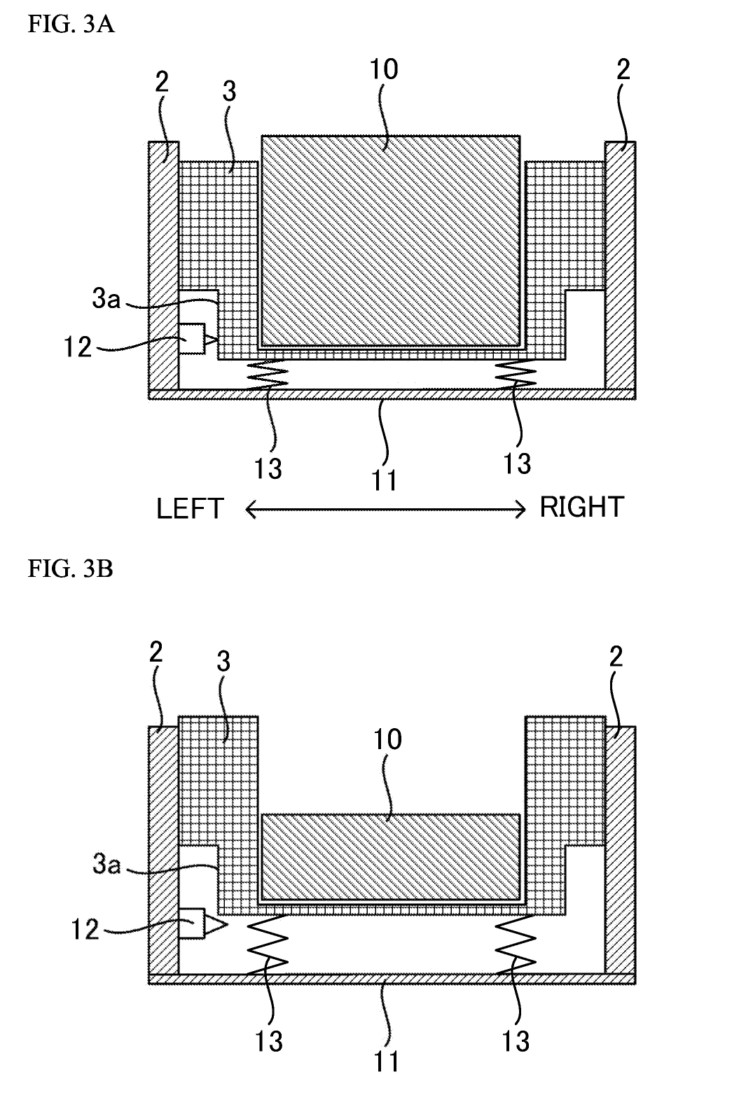

In FIG. 2A and FIG. 2B, the mechanical switch 12 is located under the inside holder 3 and on the bottom plate 11. However, the mechanical switch 12 may be arranged, for example, on the outside holder 2 (i.e., the side surface of the printer 1) as illustrated in FIG. 3A and FIG. 3B. In this case, as illustrated in FIG. 3A, when the remaining amount of a roll of paper is large, the roll of paper 10 weighs down the inside holder 3, the mechanical switch 12 is located between the outside holder 2 and a side surface 3a of the inside holder 3, and the mechanical switch 12 remains pressed. As illustrated in FIG. 3B, when the remaining amount of the roll of paper 10 is small, the restoring force of the spring 13 lifts up the inside holder 3, the side surface 3a of the inside holder 3 separates from the mechanical switch 12, and the mechanical switch 12 is turned off. FIG. 3A illustrates a variation of the cross-section of the printer 1 when the remaining amount of a roll of paper is large. FIG. 3B illustrates a variation of the cross-section of the printer 1 when the remaining amount of a roll of paper is small. FIG. 3A and FIG. 3B illustrate the cross-section taken along line A-A in FIG. 1.

The inside holder 3 may have a structure without lateral sides as illustrated in FIG. 2A and FIG. 2B, or a structure having lateral sides as illustrated in FIG. 3A and FIG. 3B. In FIG. 3A and FIG. 3B, the mechanical switch 12 is located on the outside holder 2 at the left side, but may be located on the outside holder 2 at the right side.

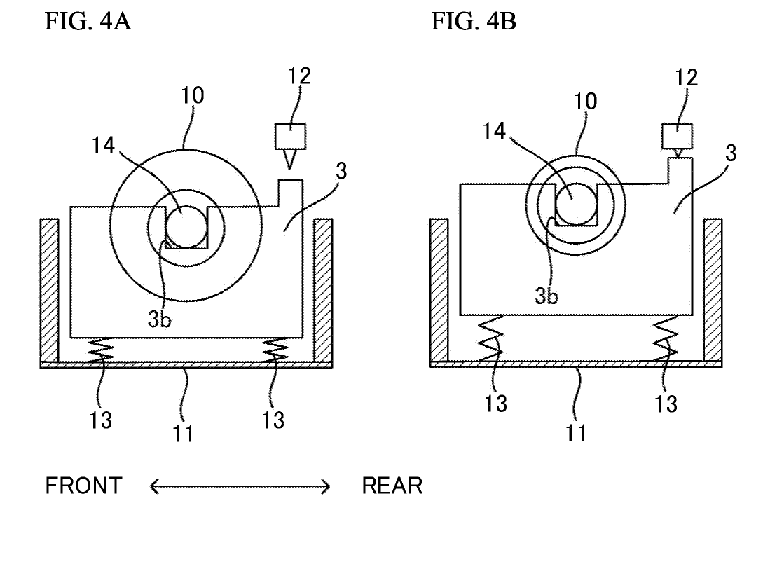

FIG. 4A illustrates another variation of the cross-section of the printer 1 when the remaining amount of a roll of paper is large. FIG. 4B illustrates another variation of the cross-section of the printer 1 when the remaining amount of a roll of paper is small. FIG. 4A and FIG. 4B illustrate the cross-section of the printer 1 as viewed from the right in FIG. 1.

In FIG. 4A and FIG. 4B, the roll of paper 10 is held by a shaft 14 penetrating through the center of the roll of paper 10, and both ends of the shaft 14 are rotatably supported by recess portions 3b of the inside holder 3. A roll of paper may be held along the curved shape of the inside holder 3 as illustrated in FIG. 1 without using the shaft 14.

In FIG. 4A and FIG. 4B, the mechanical switch 12 is located above the inside holder 3. As illustrated in FIG. 4A, when the remaining amount of a roll of paper is large, the roll of paper 10 weighs down the inside holder 3, and the inside holder 3 compresses the springs 13. Accordingly, the mechanical switch 12 faces the inside holder 3 while being apart from the inside holder 3, and the mechanical switch 12 is thus off. Thus, no signal is output from the mechanical switch 12 to the microcomputer 5. In this case, the microcomputer 5 determines that the remaining amount of the roll of paper 10 is large. As illustrated in FIG. 4B, when the remaining amount of the roll of paper 10 is small, the restoring force of the spring 13 lifts up the inside holder 3. In this case, a part of the upper surface of the inside holder 3 comes in contact with the mechanical switch 12, and presses the mechanical switch 12. When the mechanical switch 12 is pressed, an ON signal is output from the mechanical switch 12 to the microcomputer 5, and the microcomputer 5 determines that the remaining amount of the roll of paper 10 is small. The microcomputer 5 lights or blinks the LED 7 to notify the user of the near-end of the roll of paper.

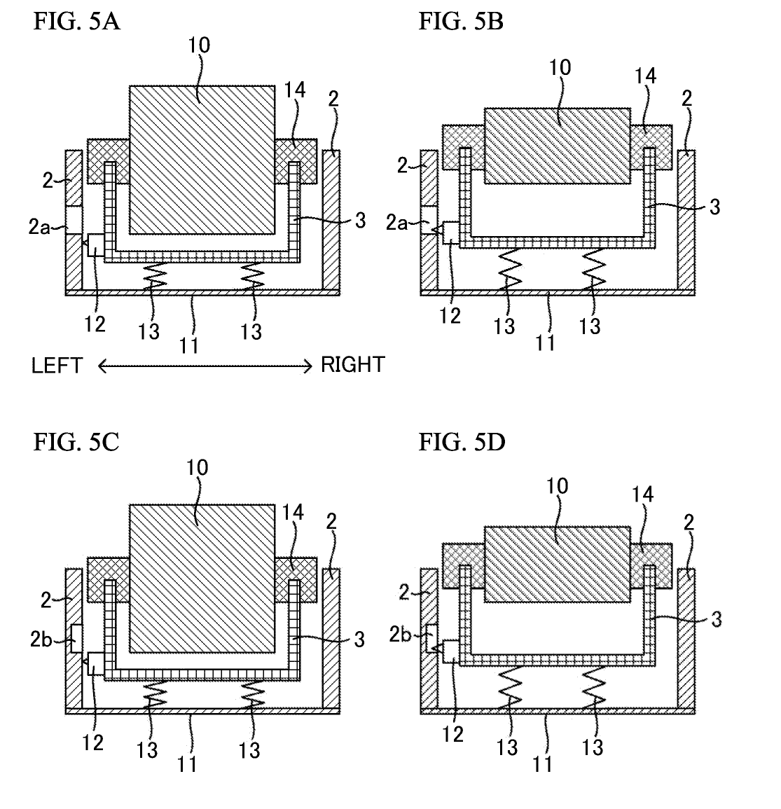

FIG. 5A and FIG. 5C illustrate other variations of the cross-section of the printer 1 when the remaining amount of a roll of paper is large. FIG. 5B and FIG. 5D illustrate other variations of the cross-section of the printer 1 when the remaining amount of a roll of paper is small. FIG. 5A through FIG. 5D illustrate the cross-section of the printer 1 as viewed from the front in FIG. 1.

In FIG. 5A through FIG. 5D, the mechanical switch 12 is located on the side surface, which faces the outside holder 2, of the inside holder 3. A penetration hole 2a illustrated in FIG. 5A and FIG. 5B or a recess portion 2b illustrated in FIG. 5C and FIG. 5D is formed in the outside holder 2. As illustrated in FIG. 5A and FIG. 5C, when the remaining amount of a roll of paper is large, the roll of paper 10 weighs down the inside holder 3, the mechanical switch 12 is located between the outside holder 2 and the side surface of the inside holder 3, and the mechanical switch 12 remains pressed. In this case, an ON signal is output from the mechanical switch 12 to the microcomputer 5, and the microcomputer 5 determines that the remaining amount of the roll of paper 10 is large.

As illustrated in FIG. 5B and FIG. 5D, as the remaining amount of the roll of paper 10 decreases, the restoring force of the spring 13 lifts up the inside holder 3, and the mechanical switch 12 gets into the penetration hole 2a or the recess portion 2b of the outside holder and is turned off. When the mechanical switch 12 is turned off, no signal is output from the mechanical switch 12 to the microcomputer 5. Thus, the microcomputer 5 determines that the remaining amount of the roll of paper 10 is small. The microcomputer 5 lights or blinks the LED 7 to notify the user of the near-end of a roll of paper.

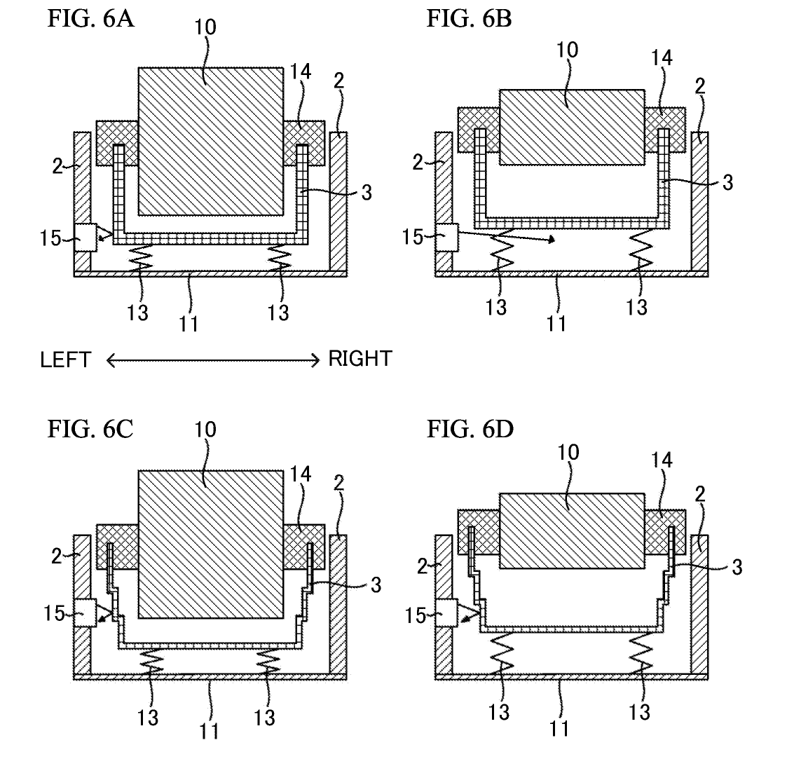

FIG. 6A and FIG. 6C are yet other variations of the cross-section of the printer 1 when the remaining amount of a roll of paper is large. FIG. 6B and FIG. 6D are yet other variations of the cross-section of the printer 1 when the remaining amount of a roll of paper is small. FIG. 6A through FIG. 6D illustrate the cross-section of the printer 1 as viewed from the front in FIG. 1.

In FIG. 6A through FIG. 6D, a reflective optical sensor 15 as the first detection unit is provided instead of the mechanical switch 12. The optical sensor 15 is located on the outside holder 2 toward the inside holder 3, and is electrically connected to the microcomputer 5.

The optical sensor 15 emits a light, receives a reflected light, and outputs a signal indicating the amount of light received to the microcomputer 5. When the distance between the optical sensor 15 and the inside holder 3 is short, the amount of light received is large. When the distance between the optical sensor 15 and the inside holder 3 is long, the amount of light received is small. Accordingly, when the amount of light received is equal to or greater than a threshold value, this means that the distance between the optical sensor 15 and the inside holder 3 is short and the inside holder 3 is weighed down with the roll of paper 10. Thus, the microcomputer 5 determines that the remaining amount of a roll of paper is large. When the amount of light received is less than the threshold value, this means that the distance between the optical sensor 15 and the inside holder 3 is long and the inside holder 3 is being lifted by the restoring force of the spring 13. Thus, the microcomputer 5 determines that the remaining amount of a roll of paper is small.

The microcomputer 5 may calculate the distance between the optical sensor 15 and the inside holder 3 based on a signal indicating the amount of light received. The microcomputer 5 may determine that the remaining amount of a roll of paper is large when the calculated distance is less than a threshold value, and determine that the remaining amount of a roll of paper is small when the calculated distance is equal to or greater than the threshold value.

As illustrated in FIG. 6A, when the remaining amount of a roll of paper is large, the roll of paper 10 weighs down the inside holder 3, the optical sensor 15 faces the inside holder 3, emits a light, receives a reflected light, and outputs a signal indicating the amount of light received to the microcomputer 5. In this case, the amount of light received by the optical sensor 15 is equal to or greater than the threshold value. Thus, the microcomputer 5 determines that the remaining amount of a roll of paper is large.

When the remaining amount of the roll of paper 10 is small as illustrated in FIG. 6B, the restoring force of the spring 13 lifts up the inside holder 3. In this case, the optical sensor 15 receives no reflected light or receives a reflected light from the outside holder 2 facing the optical sensor 15. Thus, the amount of light received by the optical sensor 15 is less than the threshold value. Accordingly, the microcomputer 5 determines that the remaining amount of the roll of paper 10 is small. The microcomputer 5 lights or blinks the LED 7, and notifies the user of the near-end of a roll of paper.

As illustrated in FIG. 6C and FIG. 6D, steps may be formed on the side surface of the inside holder 3. More specifically, steps may be formed on the side surface of the inside holder 3 so that the width in the horizontal direction increases from the bottom to the top of the side surface.

The step (position) of the inside holder 3 reflecting a light from the optical sensor 15 in FIG. 6C differs from that in FIG. 6D. In the case of FIG. 6C, since the distance between the optical sensor 15 and the inside holder 3 is less than that in FIG. 6D, the amount of light received is greater than that in FIG. 6D. Thus, by setting a threshold value at a value between the amount of light received in the case of FIG. 6C and the amount of light received in the case of FIG. 6D, the microcomputer 5 is able to appropriately determine whether the remaining amount of a roll of paper is large or small. In addition, by providing steps on the side surface of the inside holder 3 to change the reflection distance of a light from the optical sensor 15, the sensor level changes, and it becomes possible to detect the change in remaining amount of a roll of paper.

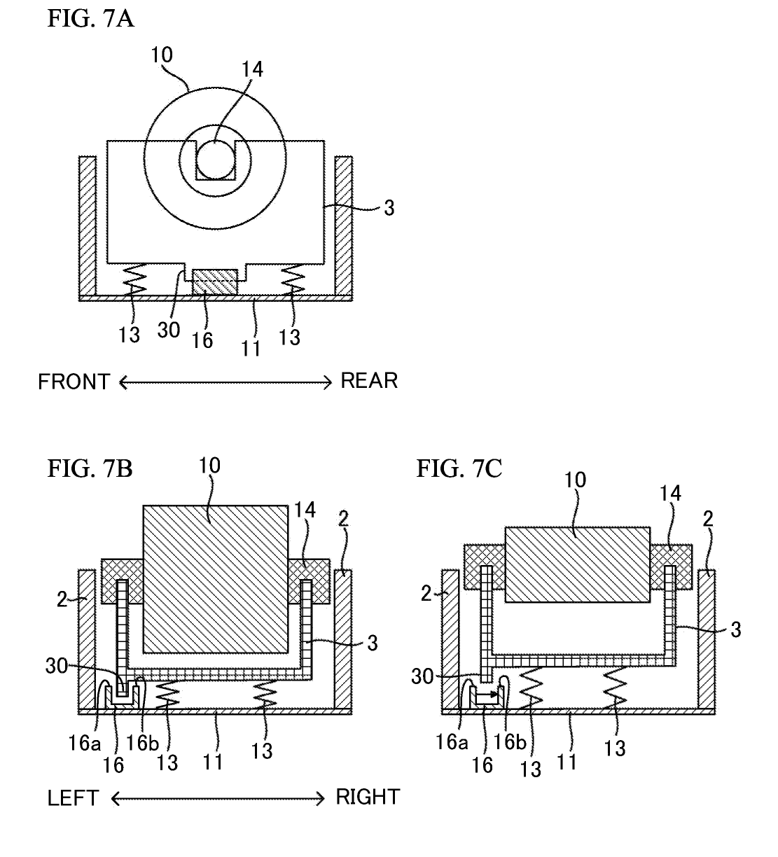

FIG. 7A is a cross-sectional view of the printer 1 as viewed from the right in FIG. 1. FIG. 7B illustrates yet another variation of the cross-section of the printer 1 when the remaining amount of a roll of paper is large. FIG. 7C illustrates yet another variation of the cross-section of the printer 1 when the remaining amount of a roll of paper is small. FIG. 7B and FIG. 7C illustrate the cross-section of the printer 1 as viewed from the front in FIG. 1.

As illustrated in FIG. 7A through FIG. 7C, a transmissive optical sensor 16 is located on the bottom plate 11. The optical sensor 16 is electrically connected to the microcomputer 5. The optical sensor 16 includes a light-emitting unit 16a that emits a light and a light-receiving unit 16b that receives the light emitted from the light-emitting unit 16a. When receiving a light from the light-emitting unit 16a within a predetermined time period from the light emission, the light-receiving unit 16b outputs an ON signal to the microcomputer 5, and when not receiving a light from the light-emitting unit 16a within the predetermined time period from the light emission, outputs an OFF signal to the microcomputer 5.

As illustrated in FIG. 7A, a protrusion portion 30 protruding downward is formed at the lower end of the inside holder 3. As illustrated in FIG. 7B, the protrusion portion 30 is configured so as to be located between the light-emitting unit 16a and the light-receiving unit 16b when the remaining amount of a roll of paper is large.

As illustrated in FIG. 7B, when the remaining amount of a roll of paper is large, the roll of paper 10 weighs down the inside holder 3, and the light-emitting unit 16a of the optical sensor 16 emits a light. Since the protrusion portion 30 is located between the light-emitting unit 16a and the light-receiving unit 16b and blocks the light from the light-emitting unit 16a, the light-receiving unit 16b does not receive the light from the light-emitting unit 16a and thus outputs an OFF signal to the microcomputer 5. The microcomputer 5 determines that the remaining amount of a roll of paper is large based on the off signal from the light-receiving unit 16b.

As illustrated in FIG. 7C, when the remaining amount of the roll of paper 10 is small, the restoring force of the spring 13 lifts up the inside holder 3 and the protrusion portion 30. In this case, the protrusion portion 30 does not block a light from the light-emitting unit 16a, and the light-receiving unit 16b receives the light from the light-emitting unit 16a and outputs an ON signal to the microcomputer 5. The microcomputer 5 determines that the remaining amount of a roll of paper is small based on the ON signal from the light-receiving unit 16b. The microcomputer 5 lights or blinks the LED 7, and notifies the user of the near-end of a roll of paper.

As described above, the printer 1 includes the inside holder 3 holding the roll of paper 10, the spring 13 supporting the inside holder 3 so that the inside holder 3 is slidable in the vertical direction, the mechanical switch 12 that detects whether the mechanical switch 12 is in contact with the inside holder 3, and the microcomputer 5 that detects the near-end of the roll of paper 10 based on the detection result by the mechanical switch 12. Accordingly, unlike the conventional technique, the near-end of the roll of paper 10 is detected based on the contact position or non-contact position with the inside holder 3 by the mechanical switch 12 without detecting the outside diameter of the roll of paper 10. Therefore, regardless of the state of the outside diameter of the roll of paper 10, the detection accuracy of the near-end of the roll of paper 10 is improved.

The printer 1 includes the inside holder 3 that holds the roll of paper 10, the spring 13 that supports the inside holder 3 so that the inside holder 3 is slidable in the vertical direction, the optical sensor 15 that emits a light to the inside holder 3 and detects the amount of received reflected light by the inside holder 3, and the microcomputer 5 that detects the near-end of the roll of paper 10 based on the detection result by the optical sensor 15. Accordingly, unlike the conventional technique, the near-end of the roll of paper 10 is detected based on the amount of light received by the optical sensor 15 without detecting the outside diameter of the roll of paper 10. Therefore, regardless of the state of the outside diameter of the roll of paper 10, the detection accuracy of the near-end of the roll of paper 10 is improved.

Furthermore, in the present embodiment, none of the mechanical switch 12 and the optical sensors 15 and 16 is in direct contact with the roll of paper 10. Thus, scratching or folding of the roll of paper 10 is prevented.

The present embodiment uses the LED 7 for notification of the near-end, but the notification of the near-end may be executed by other methods. For example, notification of the near-end may be performed by data communication to a superior device connected to the printer 1.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A printer comprising:
a holding member configured to hold a roll of paper;
an elastic member configured to support the holding member so that the holding member is slidable in a vertical direction;
a first detection unit configured to detect a position of the holding member; and
a second detection unit that detects a near-end of the roll of paper based on a detection result by the first detection unit.

2. The printer according to claim 1, wherein
the first detection unit is located above the holding member, under the holding member, or at a location facing a side surface of the holding member.

3. The printer according to claim 1, further comprising
a chassis configured to hold the holding member through the elastic member, wherein
the first detection unit is located on a side surface, which faces the chassis, of the holding member, and
the chassis has a penetration hole or a recess portion at a position facing a position at which the first detection unit is located when the first detection unit detects a near-end of the roll of paper.

4. The printer according to claim 1, wherein
a side surface, which faces the first detection unit, of the holding member has a step that makes a width of the holding member in a horizontal direction increase toward a bottom or a top.

5. The printer according to claim 1, wherein
the first detection unit includes a protrusion portion protruding in one direction, and detects a position of the holding member in the vertical direction by the protrusion portion.
